(19) United States
(12) Patent Application Publication
(10) Pub. No.: US 2026/0167416 A1
(43) Pub. Date: Jun. 18, 2026

(54) WASTE CONTAINER

(71) Applicant: Correctional Technologies, Inc., Willowbrook, IL (US)

(72) Inventor: Joseph R. Claffy, Western Springs, IL (US)

(21) Appl. No.: 19/421,766

(22) Filed: Dec. 16, 2025

Related U.S. Application Data
(60) Provisional application No. 63/734,466, filed on Dec. 16, 2024.

(51) Int. Cl. B65F 1/14; B65F 1/06; B65F 1/16

(52) U.S. Cl. CPC B65F 1/1431; B65F 1/06; B65F 1/1607; B65F 2250/1143

(57) ABSTRACT

In one aspect, a waste container having a waste chute including a waste inlet and a waste outlet; a compartment including a door movable between open and closed positions and a lock to secure the door in the closed position; a liner to receive a flexible plastic bag, the liner sized to be positioned in the compartment below the waste outlet; and a retainer configured to releasably connect to the liner to secure the flexible plastic bag to the liner. The waste chute includes an upper portion configured to receive waste from the waste inlet and direct the waste in a first direction and a lower portion configured to receive the waste from the upper portion of the waste chute and direct the waste toward the waste outlet in a second direction transverse to the first direction.

### CROSS-REFERENCE TO RELATED APPLICATION

This application claims the benefit of U.S. Provisional Application No. 63/734,466 filed Dec. 16, 2024, which is incorporated by reference in its entirety.

### TECHNICAL FIELD

This disclosure relates generally to a waste container, and more specifically, relates to waste containers for correctional, mental health, and behavioral health facilities.

### BACKGROUND

Correctional, mental health, and behavioral health facilities often have waste containers. These waste containers have plastic bags in the waste containers that receive waste and are periodically replaced with a new bag as part of emptying the waste container. A patient of a mental health, behavioral health, or correctional facility may attempt to use a plastic bag of a waste container to injure himself or others.

### BRIEF DESCRIPTION OF DRAWINGS

FIG. 1 is a perspective view of a waste container having an upper lid with a waste chute opening to receive waste and a lower receptacle to store the waste until emptying of the waste container;

FIG. 2 is a partially exploded view of the waste container of FIG. 1 showing a door of the receptacle opened and a liner and a retainer removed from a compartment of the receptacle;

FIG. 3 is a perspective view of the waste container of FIG. 1 showing an interior of the compartment of the receptacle with the liner and retainer removed from the waste container;

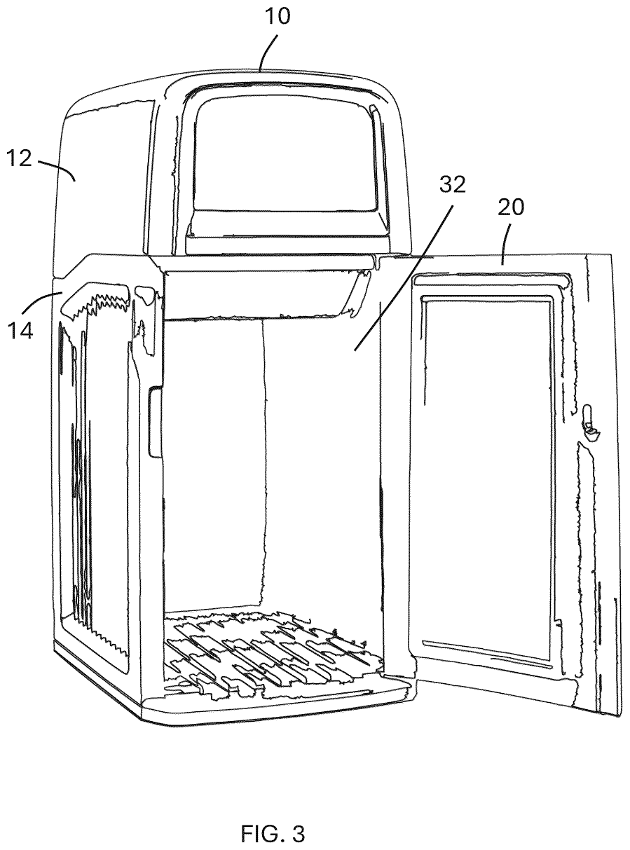

FIG. 4 is a cross-sectional view taken across line 4-4 in FIG. 1;

FIG. 5 is an enlarged view of a portion of the waste container shown in the dashed box in FIG. 4;

FIG. 6 is a cross-sectional view of the waste container taken across line 6-6 in FIG. 1;

FIG. 7 is an enlarged view of the area shown in the dashed box of FIG. 6;

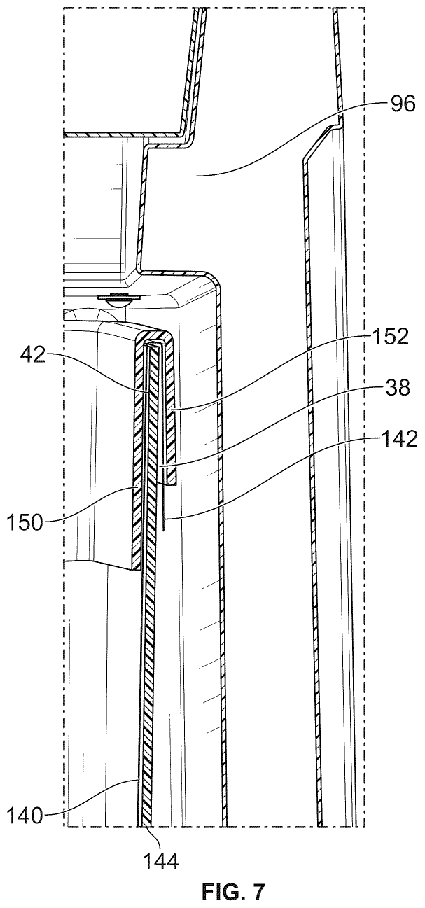

FIG. 8 is a cross-sectional view of the waste container taken along line 8-8 in FIG. 1;

FIG. 9 is a rear perspective view of the receptacle of FIG. 1 with the door and the upper lid removed;

FIG. 10 is a front perspective view of the receptacle of FIG. 9 showing an inclined floor of the compartment of the receptacle with grooves and channels to direct liquid outward from the compartment;

FIG. 11 is a cross-sectional view of the lid of FIG. 1 taken across line 11-11 in FIG. 1 showing an inclined waste chute of the lid.

### DETAILED DESCRIPTION

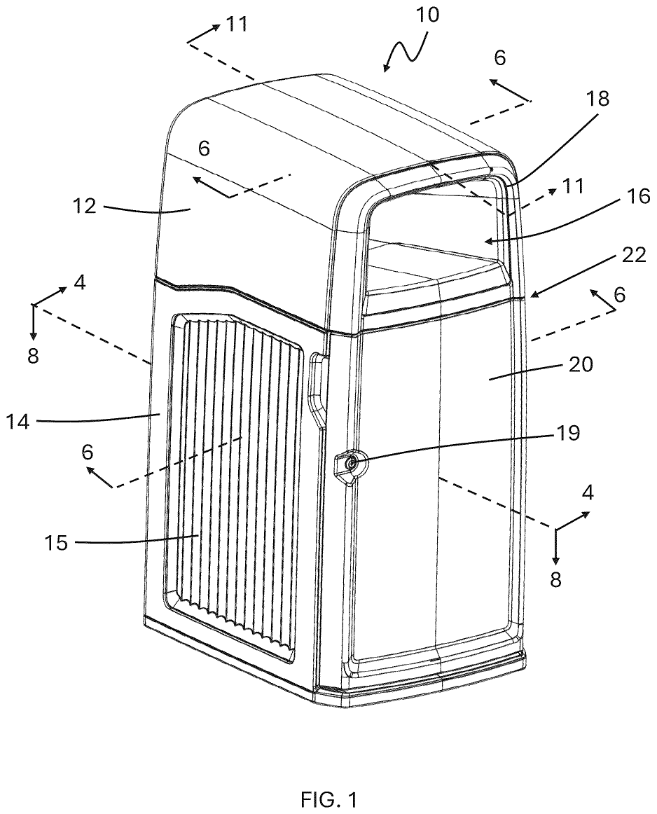

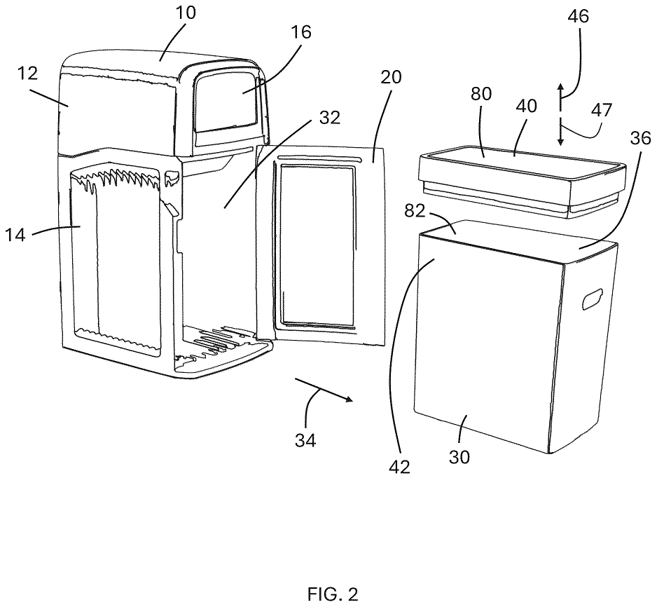

Regarding FIG. 1, a waste container 10 is provided having an upper portion such as a lid 12 and a lower portion such as a receptacle 14. The receptacle 14 has a body 15 and a door 20 pivotally connected to the body 15. The receptacle 14 has a lock 19 for selectively securing the door 20 in a closed position (see FIG. 1) or permitting the door 20 to be pivoted to an open position (see FIG. 2).

The lid 12, receptacle body 15, and receptacle door 20 may each have a unitary, one-piece construction. The lid 12, receptacle body 15, and receptacle door 20 may each be rotationally molded plastic, such as by rotationally molded high-impact polyethylene. The lid 12, receptacle body 15, and receptacle door 20 may each be hollow or may contain a structural foam. In another embodiment, the lid 12 and the receptacle body 15 have a unitary, one-piece construction.

The waste container 10 lacks sharp exterior corners, sharp exterior edges, and exterior through openings that a patient could use to injure themselves with. Further, the lid 12 has a waste chute 16 with a waste inlet opening 18 that is free of doors or other movable obstructions that a patient could use to injure themselves with.

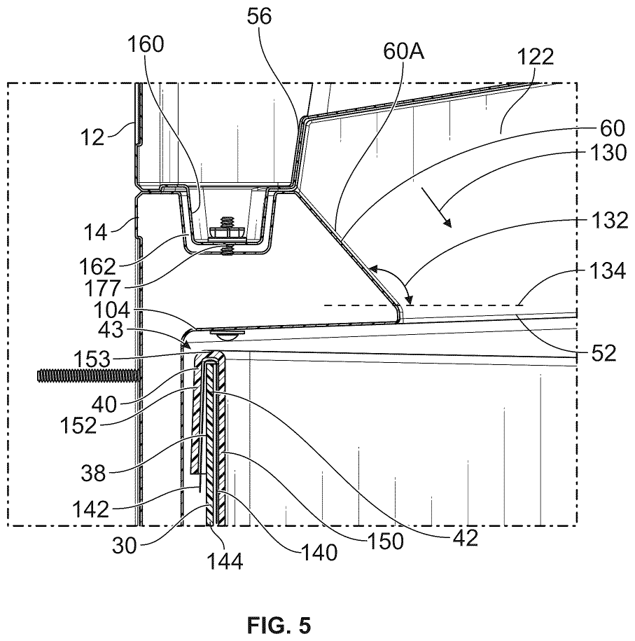

Regarding FIG. 2, the waste container 10 has a liner 30 that may be shifted out of a compartment 32 of the receptacle 14 in direction 34 once the door 20 has been opened. The liner 30 is positioned in a compartment 32 to receive waste placed into the waste chute 16. The liner 30 has an interior 36 that may receive a flexible plastic bag 38 (see FIG. 5). The waste container 10 has a retainer 40 configured to be positioned on a rim 42 of the liner 30 to secure the bag 38 to the liner 30. In this manner, the retainer 40 may be slid upward in direction 46 (see FIG. 2) from the rim 42 to disengage from the liner 30 and permit removal of the bag 38 and waste therein. Conversely, the retainer 40 is slid downward in direction 47 onto the rim 42 to engage the retainer 40 with the liner 30 and secure the bag 38 (if used) between the retainer 40 and the liner 30. In another approach, a bag is not used with the liner 30. The liner 30 may be molded plastic.

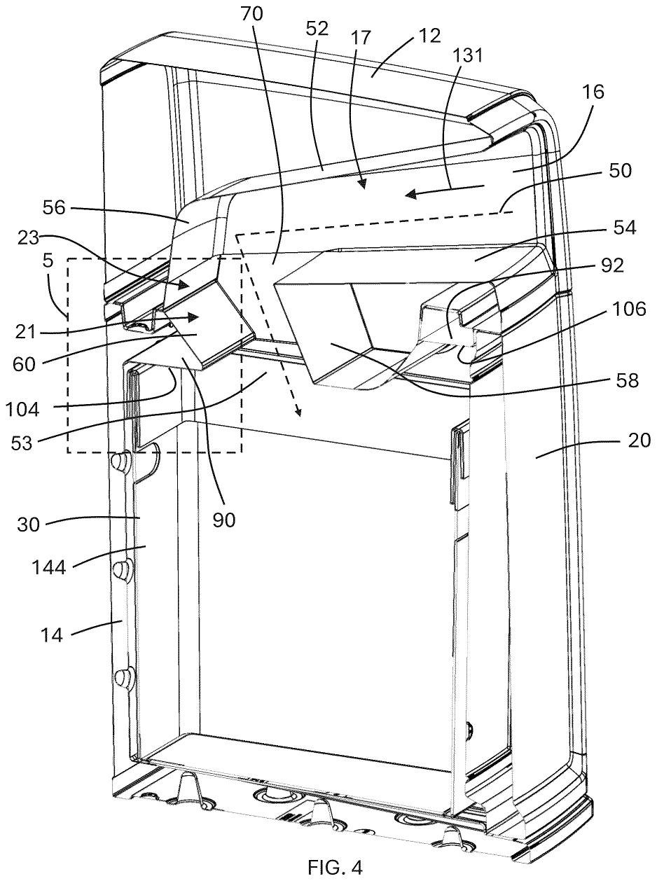

Regarding FIG. 4, the waste chute 16 includes an upper portion 17 that directs waste in a first direction 131, a lower portion 21 that directs waste in a second direction 130 (see FIG. 5) that is transverse to the first direction 131, and a redirecting portion 23 for redirecting the waste between the first and second portions 17, 21 of the waste chute 16. The waste chute 16 thereby provides a tortuous path for waste that makes it difficult for a person to stick their arm into the chute 16 and access the bag 38.

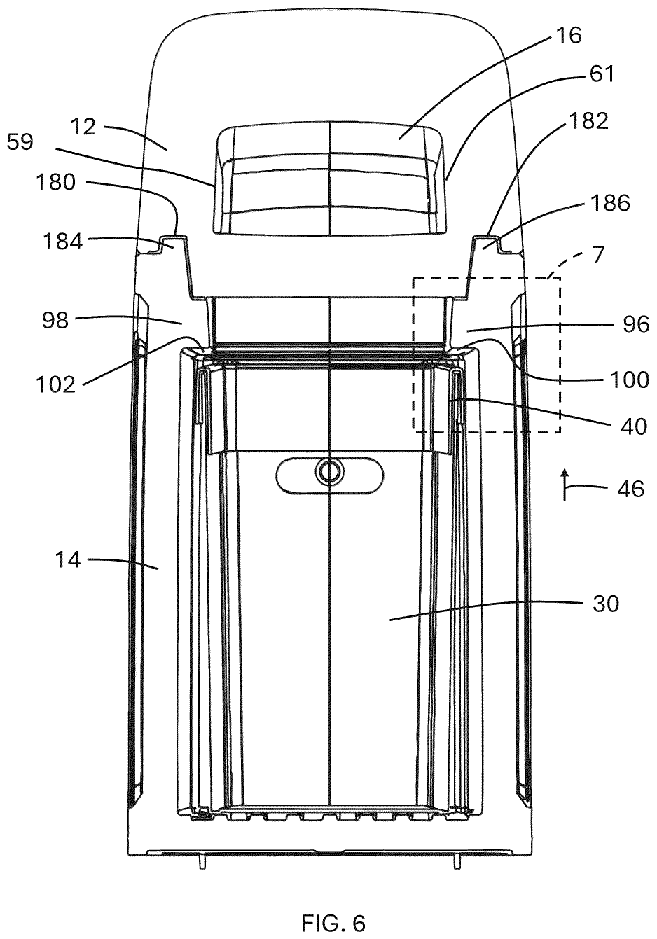

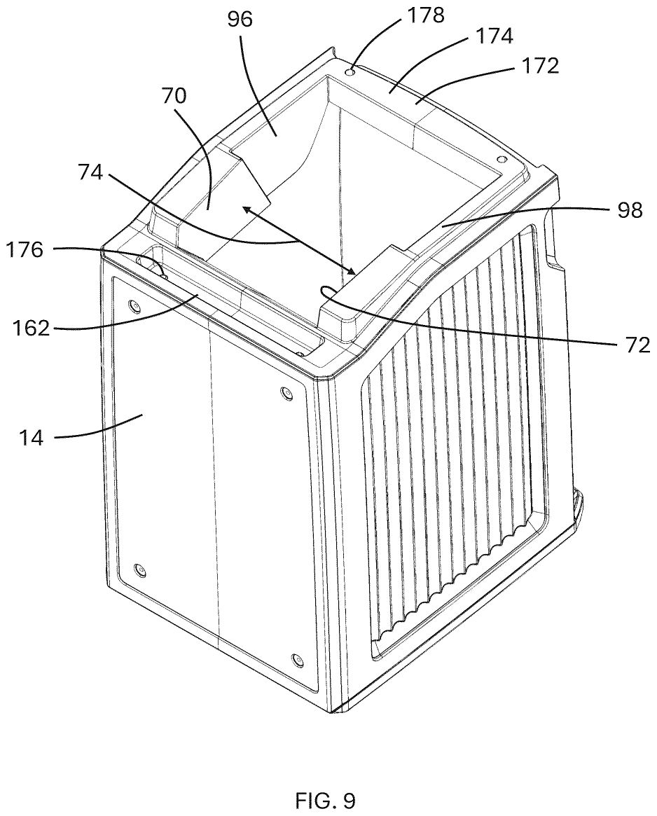

More specifically, the waste chute 16 includes a top baffle 52, a front upper slide baffle 54, a rear upper baffle 56, a front lower baffle 58, and side baffles 59, 61 (see FIG. 6) of the lid 12. The baffles 52, 54, 56, 58, 59, 61 direct waste along the path 50 toward a waste chute outlet opening 53. The receptacle 14 includes a rear lower baffle 60 and side baffles 70, 72 (see FIG. 9) separated by a spacing 74. The baffles 58, 60, 70, 72 form the waste outlet opening 53 of the waste chute 16. The waste outlet opening 53 is significantly smaller than an upper opening 80 (see FIG. 2) of the retainer 40 and an upper opening 82 of the liner 30. The smaller waste outlet opening 53 limits the ability of a patient to extend his arm through the waste chute 16 and bend his arm in the waste chute 16 in an attempt to access the bag 38 and/or liner 30.

Regarding FIGS. 4 and 9, the lid 12 and receptacle 14 have overhanging portions 90, 92, 96, 98 that overhang or extend horizontally over the retainer 40 to limit upward movement of the retainer 40 and disengagement of the retainer 40 from the rim 42 of the liner 30. Stated differently, the overhanging portions 90, 92, 96, 98 inhibit removal of the retainer 40 from the liner 30 when the liner 30 is in the compartment 32 of the receptacle 14. The lid 12 and receptacle 14 thereby cooperate to inhibit a user from reaching their arm into the waste chute 16 and removing the bag 38 from the liner 30. Instead, any attempted upward movement of the retainer 40 in direction 46 when the liner 30 is in the receptacle 14 causes the retainer 40 to abut or contact lower stop surfaces 100, 102, 104, 106 (see FIG. 6) of the lid 12 and receptacle 14. The lower stop surfaces 100, 102, 104, 106 thereby keep the retainer 40 on the liner 30 and resist removal of the bag 38 from the liner 30.

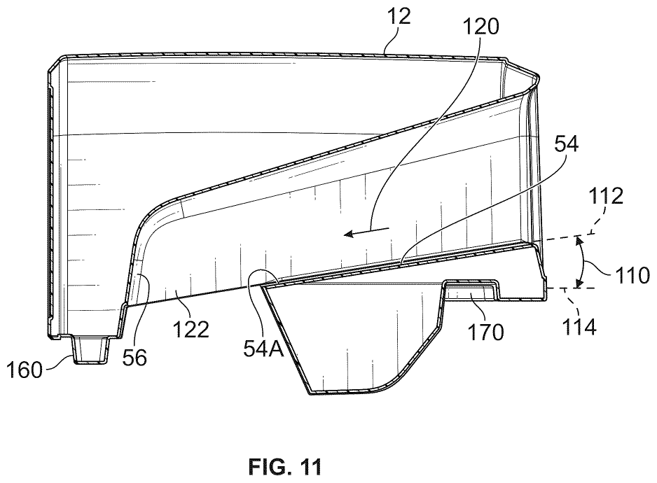

Regarding FIG. 11, the front upper slide baffle 54 has a smooth surface 54A and extends at an angle 110 along an axis 112 relative to a horizontal axis 114. Waste positioned on the front upper slide baffle 54 slides, under the effect of gravity, in direction 120 toward the rear upper baffle 56 and a lid outlet opening 122 of the lid 12. Turning to FIG. 5, the waste travels from the lid outlet opening 122 onto the rear lower baffle 60 of the receptacle 14. The rear lower baffle 60 has a smooth surface 60A that permits the waste to slide downward in direction 130. The direction 130 is transverse to an initial direction 131 that the waste travels along in the upper portion

The rear baffle 60 extends at an angle 132 relative to a horizontal axis 134 such that waste travels along the baffle 60 under the effect of gravity toward the waste outlet opening 53 and into the bag 38 (or directly into the liner 30 if no bag is used).

Regarding FIG. 5, the liner 30 is shown with the bag 38 therein including a bag portion 140 in the liner 30 and a bag portion 142 folded over the rim 42 and outward of a wall portion 144 of the liner 30. The retainer 40 has a channel 43 with a generally U-shaped cross section including an inner portion 150 that extends along an inner surface of the liner 30, an outer portion 152 that extends along an outer surface of the liner 30, and a connecting portion 153 connecting the inner and outer portions 150, 152. In this manner, the folded-over portion of the bag 38 on the rim 42 of the liner 30 is captured on the liner 30 by the retainer 40 once the channel 43 engages the rim 42.

Regarding FIGS. 5 and 11, the lid 12 has a rear ridge 160 that is received in a rear channel 162 of the receptacle 14 and a front channel 170 that receives a front ridge 172 (see FIG. 9) of a cross member 174 of the receptacle 14. The rear channel 162 and front ridge 172 have openings 176, 178 to receive hardware or fasteners 177 (see FIG. 5) for securing the lid 12 to the receptacle 14. The fasteners 177 may include, for example, bolts or screws that engage nuts to mechanically fix the lid 12 to the receptacle 14. The lid 12 and receptacle 14 limit access to the fasteners 177 from outside of the waste container 10.

Regarding FIG. 6, the lid 12 has side channels 180, 182 that receive side ridges 184, 186 of the receptacle 14. The interlocking ridges and channels 160, 162; 170, 172; 180, 184; and 180, 186 provide interlocking engagement between the lid 12 and receptacle 14. The interlocking engagement between the lid 12 and receptacle 14 inhibits a patient from separating the lid 12 from the receptacle 14 by shearing or forcing the lid 12 off of the receptacle 14 in a horizontal direction relative to the receptacle 14.

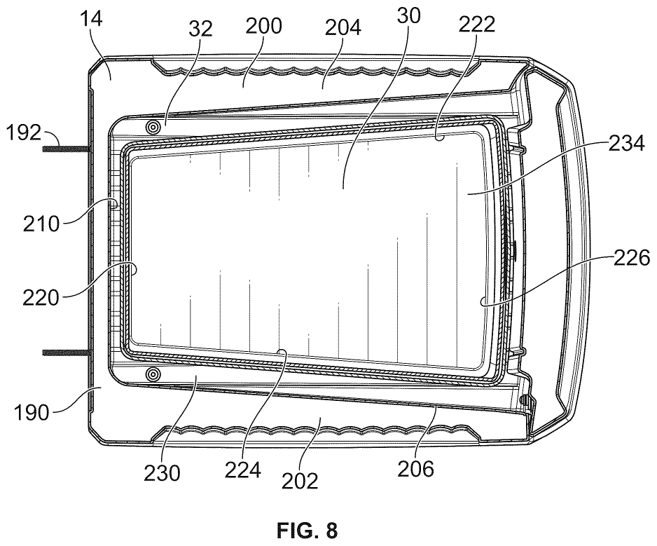

Regarding FIG. 8, the receptacle 14 has a rear wall portion 190 that receives one or more fasteners 192 for securing the waste container 10 to a wall. The receptacle 14 has side wall portions 200, 202 with tapered side wall inner surfaces 204, 206 that flare apart as the tapered side wall inner surfaces 204, 206 extend away from a narrow rear inner surface portion 210 of the rear wall portion 190. Similarly, the liner 30 has side walls, such as rear wall portion 220 and side wall portions 222, 224. The side wall portions 222, 224 flare apart as the side wall portions 222, 224 extend away from the narrow rear wall portion 220 until reaching a wider front wall portion 226 of the liner 30. In this manner, the compartment 32 and liner 30 have a mating, generally wedge-shape that widens as the compartment 32 and liner 30 extend toward the door 20. The wedge-shaped compartment 32 operates in conjunction with a lower support surface 230 of the receptacle 14 to collect and direct liquid out of the compartment 32 during cleaning of the receptacle 14.

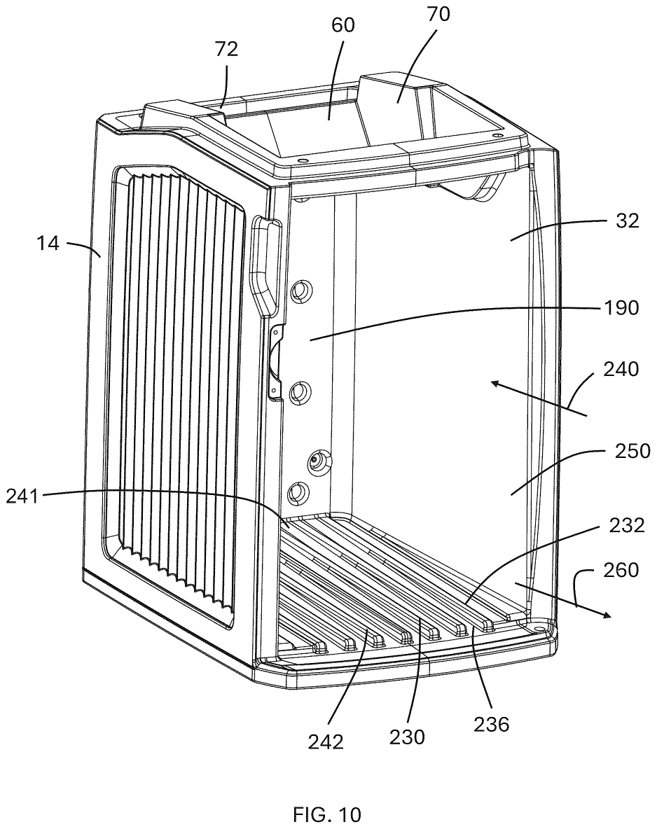

Regarding FIG. 10, the lower support surface 230 is inclined and has ridges 232 to support a bottom wall 234 (see FIG. 8) of the liner 30 and grooves 236 separating the ridges 232. Liquid sprayed generally in direction 240 into the compartment 32 to clean the interior of the compartment 32 may fall onto a raised rear portion 241 of the lower support surface 230 and drain toward a lowered front portion 242 of the lower support surface 230 under the effect of gravity. Further, the inclined lower support surface 230 facilitates draining out of the waste container 10 of any liquid that overflows from the liner 30 onto the lower support surface 230.

Additionally, the flared or tapered side wall inner surfaces 204, 206 present a wider opening 250 away from the rear wall portion 190 to encourage liquid sprayed into the compartment 32 to travel outward in direction 260 from the compartment 32.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

What is claimed is:

1. A waste container comprising:
a waste chute including a waste inlet and a waste outlet;
a compartment including a door movable between open and closed positions and a lock to secure the door in the closed position;
a liner to receive a flexible plastic bag, the liner sized to be positioned in the compartment below the waste outlet;
a retainer configured to releasably connect to the liner to secure the flexible plastic bag to the liner;
an upper portion of the waste chute configured to receive waste from the waste inlet and direct the waste in a first direction;
a lower portion of the waste chute configured to receive the waste from the upper portion of the waste chute and direct the waste toward the waste outlet in a second direction transverse to the first direction.

2. The waste container of claim 1 wherein the upper portion of the waste chute includes an upper slide baffle; and
wherein the lower portion of the waste chute includes a lower slide baffle.

3. The waste container of claim 1 wherein the upper portion of the waste chute includes a top baffle and an upper slide baffle extending along the first direction; and
wherein the second portion of the waste chute includes a rear lower baffle and a front lower baffle extending along the second direction.

4. The waste container of claim 3 further comprising a rear upper baffle extending transverse to and connecting the top baffle and the rear lower baffle.

5. The waste container of claim 1 wherein the waste chute further comprises an intermediate portion connecting the upper portion to the lower portion, the intermediate portion of the waste chute configured to redirect the waste from the first direction to the second direction.

6. The waste container of claim 1 comprising a receptacle and a lid assembled with the receptacle;
wherein the receptacle includes the compartment;
wherein the lid defines at least a portion of the upper portion of the waste chute; and
wherein the receptacle defines at least a portion of the lower portion of the waste chute.

7. The waste container of claim 1 comprising a receptacle and a lid assembled with the receptacle;
wherein the upper portion of the waste chute includes a top baffle and an upper slide baffle extending along the first direction;
wherein the second portion of the waste chute includes a rear lower baffle and a front lower baffle extending along the second direction;
wherein the receptacle includes the rear lower baffle; and
wherein the lid includes the top baffle, upper slide baffle, and front lower baffle.

8. The waste container of claim 7 wherein the lid includes rotationally molded plastic.

9. The waste container of claim 7 wherein the receptacle includes a body and the door movably connected to the body;
wherein the receptacle body includes the rear lower baffle; and
wherein the lid and the receptacle body each include rotationally molded plastic.

10. The waste container of claim 1 comprising a receptacle and a lid assembled with the receptacle;
wherein the receptacle includes a body and the door movably connected to the body; and
wherein at least one of the lid and the receptacle body is rotationally molded plastic.

11. The waste container of claim 1 comprising a receptacle and a lid assembled with the receptacle;
wherein the receptacle includes the compartment; and
wherein the receptacle and the lid include at least one interlocking ridge and channel.

12. The waste container of claim 11 further comprising at least one fastener extending in openings of the ridge and channel.

13. The waste container of claim 11 wherein the at least one interlocking ridge and channel include:
a first ridge engaged with a first channel on one side of the waste outlet; and
a second ridge engaged with a second channel on an opposite side of the waste outlet.

14. The waste container of claim 1 comprising a receptacle that includes the compartment;
wherein the liner includes an upper rim; and
wherein the receptacle includes at least one overhanging portion extending over the upper rim with the liner received in the compartment to resist access to the upper rim of the liner.

15. The waste container of claim 14 wherein the retainer is configured to connect to the upper rim of the liner and be disposed vertically intermediate the upper rim and the at least one overhanging portion.

16. The waste container of claim 1 wherein the liner includes an upper rim; and
wherein the retainer includes a channel configured to fit onto the upper rim and secure the flexible plastic bag to the upper rim.

17. The waste container of claim 1 wherein the liner includes a bottom wall, at least one side wall upstanding from the bottom wall, and an upper rim of the at least one side wall; and
wherein the retainer includes an inner portion for being positioned proximate an interior surface of the at least one side wall of the liner, an outer portion for being positioned proximate an exterior surface of the at least one side wall, and a connecting portion connecting the inner and outer portions and configured to be supported on the upper rim of the liner.

18. The waste container of claim 1 comprising a receptacle that includes the compartment;
wherein the receptacle has a front opening closed by the door and a rear wall opposite the front opening; and
wherein the rear wall includes recesses to receive fasteners for securing the receptacle to a surface.

19. The waste container of claim 1 wherein the compartment includes a rear wall and a pair of inclined first side walls extending apart as the inclined side walls extend away from the rear wall; and
wherein the liner includes a bottom wall and a pair of inclined second side walls upstanding from the bottom wall, the inclined second side walls of the liner configured to complement the inclined first side walls with the liner received in the compartment.

20. The waste container of claim 1 wherein the compartment includes a front opening to be closed by the door and a rear wall opposite the opening; and
wherein the compartment includes an inclined floor extending downwardly as the floor extends away from the rear wall.
